(19) United States
(12) Patent Application Publication
(10) Pub. No.: US 2025/0293831 A1
(43) Pub. Date: Sep. 18, 2025

(54) DMRS DESIGN WITH CDM GROUP EXPANSION

(71) Applicant: APPLE INC., Cupertino, CA (US)

(72) Inventors: Haitong Sun, Cupertino, CA (US); Dawei Zhang, Saratoga, CA (US); Yushu Zhang, Beijing (CN); Hong He, San Jose, CA (US); Chunxuan Ye, San Diego, CA (US); Huaning Niu, San Jose, CA (US); Wei Zeng, San Diego, CA (US); Seyed Ali Akbar Fakoorian, San Diego, CA (US); Weidong Yang, San Diego, CA (US); Oghenekome Oteri, San Diego, CA (US); Chunhai Yao, Beijing (CN); Sigen Ye, San Diego, CA (US)

(21) Appl. No.: 18/859,026

(22) PCT Filed: Apr. 28, 2022
(86) PCT No.: PCT/CN2022/089753

§ 371 Date: Oct. 22, 2024

(51) Int. Cl. H04L 5/00; H04J 13/10; H04J 13/12

(52) U.S. Cl. CPC H04L 5/0051; H04J 13/107; H04J 13/12; H04L 5/0016; H04L 5/0044

(57) ABSTRACT

The present disclosure relates to demodulation reference signal (DMRS) design with code division multiplexing (CDM) group expansion. A network device may be configured to generate a DMRS and send the DMRS to a wireless device. The DMRS may be coded with one of a plurality of expanded orthogonal cover codes (OCCs) belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

### TECHNICAL FIELD

This application relates generally to wireless communication systems, including design of a demodulation reference signal (DMRS) for transmission between a wireless device and a network device.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

A demodulation reference signal (DMRS) may be used for channel estimation and demodulation. In particular, DMRS symbols with specific patterns may be carried by a resource block and transmitted from a transmitter to a receiver. The receiver may use the received DMRS symbols with a specific pattern, which is known by the receiver in advance, for estimating the channel.

A plurality of DMRS symbols may be transmitted through a plurality of orthogonal DMRS ports which correspond to a plurality of antenna ports respectively. In order to ensure the orthogonality of the plurality of DMRS ports, time division multiplexing (TDM), frequency division multiplexing (FDM), or code division multiplexing (CDM) may be applied to the DMRS symbols. For CDM, a plurality of CDM groups are designed. Each CDM group includes a plurality of orthogonal cover codes (OCC), and the OCCs may be superposed on DMRS symbols so that the DMRS symbols occupying the same time and frequency resources may be made orthogonal by CDM.

Recently, in order to meet current or future communication requirements, a scheme which supports larger number of orthogonal DMRS ports is discussed. One possible way for supporting larger number of orthogonal DMRS ports may be expanding the CDM groups so that each CDM group may provide more orthogonal OCCs.

Embodiments in the present disclosure relate to devices and methods for DMRS design with CDM group expansion.

A network device according to some embodiments of the present disclosure may be configured to generate a DMRS and send the DMRS to a wireless device. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A wireless device according to some embodiments of the present disclosure may be configured to receive a DMRS from a network device and perform a channel estimation based on the DMRS. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A network device according to some embodiments of the present disclosure may be configured to receive a DMRS from a wireless device and perform a channel estimation based on the DMRS. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A wireless device according to some embodiments of the present disclosure may be configured to receive a control signal from a network device and generate, in response to the control signal, a DMRS to be transmitted to the network device. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A method for a network device according to some embodiments of the present disclosure may comprise generating a DMRS and sending the DMRS to a wireless device. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A method for a wireless device according to some embodiments of the present disclosure may comprise receiving a DMRS from a network device and performing a channel estimation based on the DMRS. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A method for a network device according to some embodiments of the present disclosure may comprise receiving a DMRS from a wireless device and performing a channel estimation based on the DMRS. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

A method for a wireless device according to some embodiments of the present disclosure may comprise receiving a control signal from a network device and generating, in response to the control signal, a DMRS to be transmitted to the network device. The DMRS may be coded with one of a plurality of expanded OCCs belonging to an expanded CDM group. The expanded CDM group may be generated by expanding a legacy CDM group including a plurality of legacy OCCs. The number of frequency domain elements in each of the plurality of expanded OCCs may be expanded as twice the number of frequency domain elements in each of the plurality of legacy OCCs.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIGS. 3 and 4 illustrate legacy DMRS configuration type 1 and related legacy CDM groups including legacy OCCs.

FIGS. 5 and 6 illustrate legacy DMRS configuration type 2 and related legacy CDM groups including legacy OCCs.

FIG. 7 illustrates expanded CDM groups and expanded OCCs for DMRS configuration type 1 according to some embodiments disclosed herein.

FIG. 8 illustrates expanded CDM groups and expanded OCCs for DMRS configuration type 2 according to some embodiments disclosed herein.

FIG. 9 illustrates DMRS pattern designs for DMRS configuration type 1 according to some embodiments disclosed herein.

FIG. 10 illustrates DMRS pattern designs for DMRS configuration type 2 according to some embodiments disclosed herein.

FIG. 11 illustrates a signaling diagram of an example method for downlink DMRS transmission between the network device and the wireless device according to some embodiments disclosed herein.

FIG. 12 illustrates a signaling diagram of an example method for uplink DMRS transmission between the network device and the wireless device according to some embodiments disclosed herein.

FIG. 13 illustrates a case where an expanded CDM group crosses a PRG boundary according to some embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

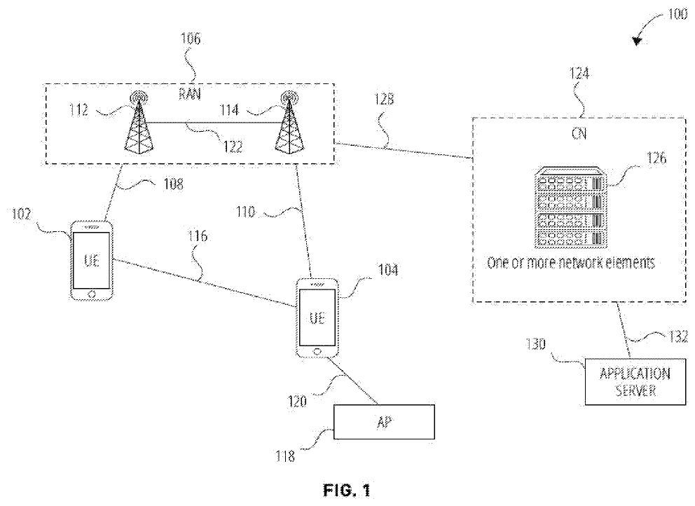

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

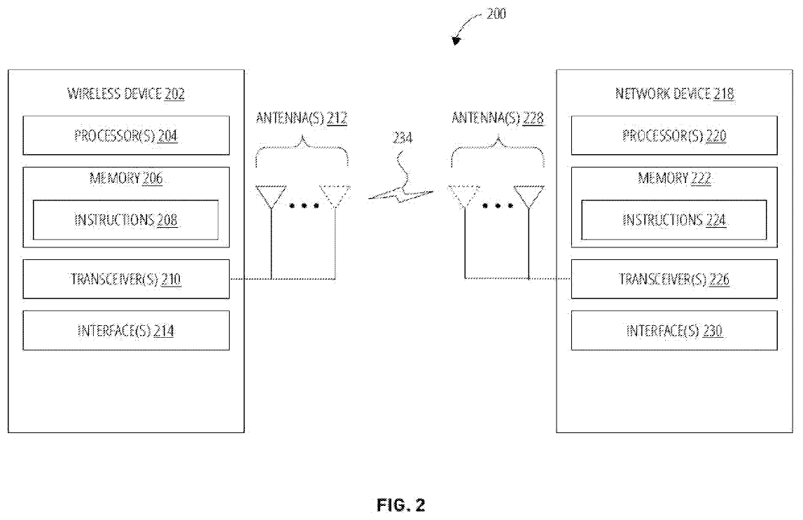

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-IMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform IMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

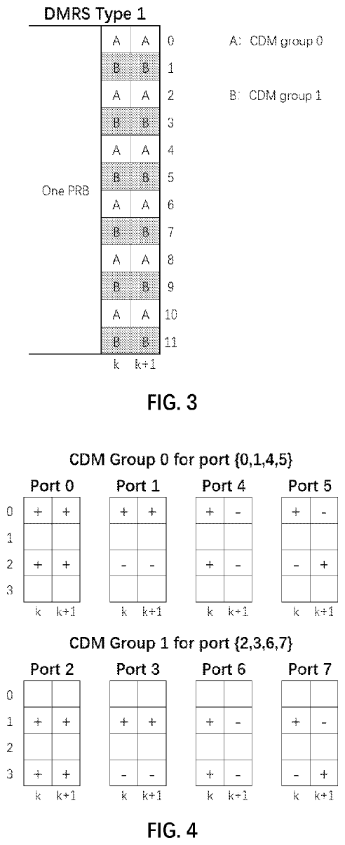

Now refer to FIGS. 3 to 6, legacy DMRS configurations and legacy CDM groups will be first introduced. It is noted that the wording “legacy” described herein means any existing scheme before the present disclosure, including but not limited to any scheme related to the LTE system standards and/or 5G or NR system standards as provided by 3GPP technical specifications.

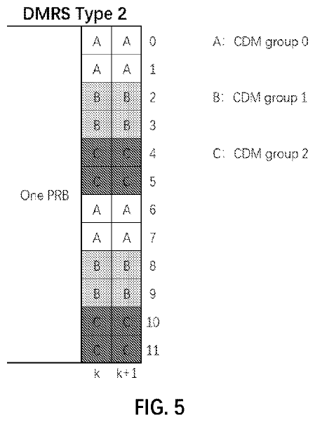

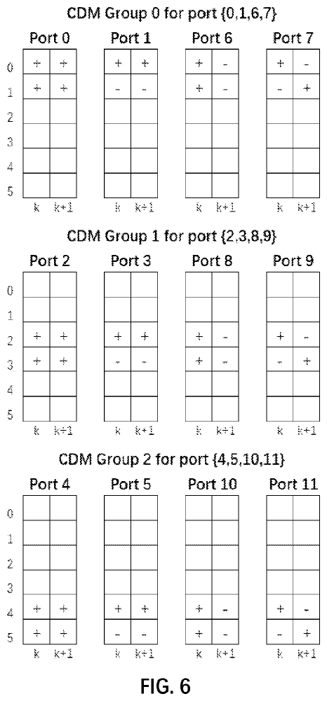

There are two legacy DMRS configuration types (also simply recited as DMRS types hereafter) 1 and 2 with different DMRS patterns. FIGS. 3 and 4 illustrate legacy DMRS configuration type 1 and related legacy CDM groups including legacy OCCs, while FIGS. 5 and 6 illustrate legacy DMRS configuration type 2 and related legacy CDM groups including legacy OCCs.

The DMRS type 1 is shown in FIG. 3. For simplicity, FIG. 3 only shows two DMRS symbols k and k+1 in time domain (horizontal direction in FIG. 3) of one physical resource block (PRB), and omits other orthogonal frequency division multiplexing (OFDM) symbols in this PRB.

For DMRS type 1, as shown in FIG. 3, for each of DMRS symbols k and k+1, in frequency domain of the physical resource block (PRB) (vertical direction in FIG. 3), the DMRS resource elements (REs) are distributed at an interval of one resource element. There are two possible DMRS patterns denoted in FIG. 3 by “A” and “B” respectively.

For DMRS pattern A in DMRS type 1, the REs in even positions in frequency domain of the PRB are occupied as DMRS REs, and thus the DMRS symbols for DMRS pattern A may be denoted as DMRS symbol Aₖ=[RE₀, RE₂, RE₄, RE₆, RE₈, RE₁₀]^{T}, and DMRS symbol Aₖ₊₁=[RE₀, RE₂, RE₄, RE₆, RE₈, RE₁₀]^{T}.

For DMRS pattern B in DMRS type 1, the REs in odd positions in frequency domain of the PRB are occupied as DMRS REs, and thus the DMRS symbols for DMRS pattern B may be denoted as DMRS symbol Bₖ=[RE₁, RE₃, RE₅, RE₇, RE₉, RE₁₁]^{T}, and DMRS symbol Bₖ₊₁=[RE₁, RE₃, RE₅, RE₇, RE₉, RE₁₁]^{T}.

For different DMRS patterns A and B, different CDM groups may be assigned. For example, the DMRS symbols Aₖ and Aₖ₊₁ for DMRS pattern A may be assigned to CDM group 0, and the DMRS symbols Bₖ and Bₖ₊₁ for DMRS pattern B may be assigned to CDM group 1.

The detailed configurations of the CDM groups for DMRS type 1 are shown in FIG. 4.

In FIG. 4, two CDM groups 0 and 1 are provided for DMRS type 1. Each CDM group has the same size to include the same number of OCCs. For CDM group 0, four OCCs are included and assigned to DMRS ports 0, 1, 4, 5 respectively. For CDM group 1, four OCCs are included and assigned to DMRS ports 2, 3, 6, 7 respectively.

For each OCC, two time-domain elements (denoted as “TD-OCC elements”) and two frequency domain elements (“FD-OCC elements”) are included. The values of FD-OCC elements and TD-OCC elements are designed so that the four OCCs included in each CDM group are orthogonal with each other. For a plurality of DMRS symbols which occupy the same time and frequency resources, they may be coded with the OCCs in one CDM group, so that the plurality of DMRS symbols may be made orthogonal by CDM. Further, for different CDM groups, as can be seen from FIG. 4, the number of OCCs are the same and the values of respective OCCs are also the same, but the RE positions of FD-OCC elements are different, which correspond respectively to the DMRS patterns. For example, for CDM group 0 corresponding to DMRS pattern A, the FD-OCC elements in each OCC locate in even REs, while for CDM group 1 corresponding to DMRS pattern B, the FD-OCC elements in each located in odd REs.

FIG. 4 illustrates the values of FD-OCC elements and TD-OCC elements in CDM groups 0 and 1 as “+” and “−”, which indicates “+1” and “−1” respectively. For each CDM group shown in FIG. 4, the four OCCs are orthogonal with each other. It is noted that the OCC designs are not limited to the values shown in FIG. 4, and other values for FD-OCC elements and TD-OCC elements may be designed.

For the coding of DMRS with the CDM group, the DMRS type (e.g., belonging to type 1 or type 2), DMRS pattern (e.g., belonging to pattern A or pattern B), and the corresponding DMRS port may be determined first. Then, the OCC for coding the DMRS may be determined. For example, for a two-symbol DMRS Aₖ and Aₖ₊₁ with DMRS type 1, DMRS pattern A and DMRS port 1, the

$$O CC = {[ \begin{matrix}+ & - \\ + & -\end{matrix} ]}^{T}$$

corresponding to DMRS port 1 in CDM group 0 will be determined for coding DMRS.

In addition, the OCC repeats in frequency domain (three times for DMRS type 1), using next entries in DMRS sequence, so that each DMRS RE in the PRB may be coded with a corresponding OCC element.

For example, for the two-symbol DMRS A_{k and k+1} expressed as

$${A}_{k and k + 1} = {[ \begin{matrix}{RE}_{k , 0} , & {RE}_{k , 2} , & {RE}_{k , 4} , & {RE}_{k , 6} , & {RE}_{k , 8} , & {RE}_{k , 10} , \\ R {E}_{k + 1 , 0} , & R {E}_{k + 1 , 2} , & R {E}_{k + 1 , 4} , & R {E}_{k + 1 , 6} , & R {E}_{k + 1 , 8} , & R {E}_{k + 1 , 10}\end{matrix} ]}^{T}$$

the coded A_{k and k+1} with OCC in CDM group 0 corresponding to DMRS port 1 may be obtained as

$$OCC coded {A}_{k and k + 1} = {[ \begin{matrix}+ {RE}_{k , 0} , & - {RE}_{k , 2} , & + {RE}_{k , 4} , & - {RE}_{k , 6} , & + {RE}_{k , 8} , & - {RE}_{k , 10} , \\ + {RE}_{k + 1 , 0} , & - {RE}_{k + 1 , 2} , & + {RE}_{k + 1 , 4} , & - {RE}_{k + 1 , 6} , & + {RE}_{k + 1 , 8} , & - {RE}_{k + 1 , 10}\end{matrix} ]}^{T}$$

wherein the

$$OCC = {[ \begin{matrix}+ & - \\ + & -\end{matrix} ]}^{T}$$

is repeated in frequency domain for three times as

$$repeated OCC = {[ \begin{matrix}+ , & - , & + , & - , & + , & - \\ + , & - , & + , & - , & + , & -\end{matrix} ]}^{T}$$

and each RE in A_{k and k+1} is multiplexed by the corresponding OCC element in the repeated OCC with the same position in the PRB.

In the above description, a two-symbol DMRS is exemplified. For two-symbol DMRSs for DMRS type 1, two CDM groups may be provided and each CDM group may include four orthogonal OCCs. Therefore, up to 8 DMRS ports may be supported. For one-symbol DMRSs for DMRS type 1, similarly, two CDM groups may be provided and each CDM group may include two orthogonal OCCs. Therefore, up to 4 DMRS ports may be supported.

Next, DMRS configuration type 2 and related legacy CDM groups including legacy OCCs will be introduced with reference to FIGS. 5 and 6.

The DMRS type 2 is shown in FIG. 5. For simplicity, FIG. 5 only shows two DMRS symbols k and k+1 in one physical resource block (PRB), and omits other OFDM symbols in this PRB.

For DMRS type 2, as shown in FIG. 5, the distributions of DMRS REs in frequency domain of the PRB are different from DMRS type 1, in which the DMRS REs are distributed consecutively in frequency domain.

There are three possible DMRS patterns denoted in FIG. 5 by “A”, “B” and “C” respectively. The DMRS symbols for DMRS pattern A in DMRS type 2 may be denoted as Aₖ=[RE₀, RE₁, RE₆, RE₇], and Aₖ₊₁=[RE₀, RE₁, RE₆, RE₇]. The DMRS symbols for DMRS pattern B in DMRS type 2 may be denoted as Bₖ=[RE₂, RE₃, RE₈, RE₉] and Bₖ₊₁=[RE₂, RE₃, RE₈, RE₉]. The DMRS symbols for DMRS pattern C in DMRS type 2 may be denoted as Cₖ=[RE₄, RE₅, RE₁₀, RE₁₁] and Cₖ₊₁=[RE₄, RE₅, RE₁₀, RE₁₁].

For different DMRS patterns A, B and C, different CDM groups may be assigned. For example, the DMRS symbols Aₖ and Aₖ₊₁ for DMRS pattern A may be assigned to CDM group 0, the DMRS symbols Bₖ and Bₖ₊₁ for DMRS pattern B may be assigned to CDM group 1, and the DMRS symbols Cₖ and Cₖ+₁ for DMRS pattern C may be assigned to CDM group 2.

The detailed configurations of the CDM groups for DMRS type 2 are shown in FIG. 6.

In FIG. 6, three CDM groups 0, 1 and 2 are provided for DMRS type 2. Each CDM group has the same size to include the same number of OCCs. For CDM group 0, four OCCs are included and assigned to DMRS ports 0, 1, 6, 7 respectively. For CDM group 1, four OCCs are included and assigned to DMRS ports 2, 3, 8, 9 respectively. For CDM group 2, four OCCs are included and assigned to DMRS ports 4, 5, 10, 11 respectively.

For each OCC, two TD-OCC elements and two FD-OCC elements are included. The values of FD-OCC elements and TD-OCC elements are designed so that the four OCCs included in each CDM group are orthogonal with each other. For a plurality of DMRS symbols which occupy the same time and frequency resources, they may be coded with the OCCs in one CDM group, so that the plurality of DMRS symbols may be made orthogonal by CDM. Further, for different CDM groups, as can be seen from FIG. 6, the number of OCCs are the same and the values of respective OCCs are also the same, but the RE positions of FD-OCC elements are different, which correspond respectively to the DMRS type. For example, for CDM group 0 corresponding to DMRS pattern A, the FD-OCC elements in each OCC locate in RE₀ and RE₁, for CDM group 1 corresponding to DMRS pattern B, the FD-OCC elements in each located in RE₂ and RE₃, and for CDM group 1 corresponding to DMRS pattern C, the FD-OCC elements in each located in RE₄ and RE₅.

FIG. 6 illustrates the values of FD-OCC elements and TD-OCC elements in CDM groups 0, 1 and 2 as “+” and “−”, which indicates “+1” and “−1” respectively. For each CDM group shown in FIG. 6, the four OCCs are orthogonal with each other. It is noted that the OCC designs are not limited to the values shown in FIG. 6, and other values for FD-OCC elements and TD-OCC elements may be designed.

For the coding of DMRS with the CDM group, the DMRS type (e.g., belonging to type 1 or type 2), DMRS pattern (e.g., belonging to pattern A or pattern B), and the corresponding DMRS port may be determined first. Then, the OCC for coding the DMRS may be determined. For example, for a two-symbol DMRS Aₖ and Aₖ₊₁ with DMRS type 2, DMRS pattern A and DMRS port 1, the

$$OCC = {[ \begin{matrix}+ & - \\ + & -\end{matrix} ]}^{T}$$

corresponding to DMRS port 1 in CDM group 0 will be determined for coding DMRS.

In addition, the OCC repeats in frequency domain (two times for DMRS type 2), using next entries in DMRS sequence, so that each DMRS RE in the PRB may be coded with the determined OCC.

For example, for the two-symbol DMRS Aₖ and k+1 expressed as

$${A}_{k and k + 1} = {[ \begin{matrix}{RE}_{k , 0} , & {RE}_{k , 1} , & {RE}_{k , 6} , & {RE}_{k , 7} \\ {RE}_{k + 1 , 0} , & {RE}_{k + 1 , 1} , & {RE}_{k + 1 , 6} , & {RE}_{k + 1 , 7}\end{matrix} ]}^{T}$$

the coded A_{k and k+1} with OCC in CDM group 0 corresponding to DMRS port 1 may be obtained as

$$OCC coded {A}_{k and k + 1} = {[ \begin{matrix}+ {RE}_{k , 0} , & - {RE}_{k , 1} , & + {RE}_{k , 6} , & - {RE}_{k , 7} \\ + {RE}_{k + 1 , 0} , & - {RE}_{k + 1 , 1} , & + {RE}_{k + 1 , 6} , & - {RE}_{k + 1 , 7}\end{matrix} ]}^{T}$$

wherein the

$$OCC = {[ \begin{matrix}+ & - \\ + & -\end{matrix} ]}^{T}$$

is repeated in frequency domain for two times as

$$repeated OCC = {[ \begin{matrix}+ , & - , & + , & - \\ + , & - , & + , & -\end{matrix} ]}^{T}$$

and each RE in A_{k and k+1} is multiplexed by the corresponding OCC value in the repeated OCC with the same position in the PRB.

In the above description, a two-symbol DMRS is exemplified. For two-symbol DMRSs for DMRS type 2, three CDM groups may be provided and each CDM group may include four orthogonal OCCs. Therefore, up to 12 DMRS ports may be supported. For one-symbol DMRSs for DMRS type 1, similarly, three CDM groups may be provided and each CDM group may include two orthogonal OCCs. Therefore, up to 6 DMRS ports may be supported.

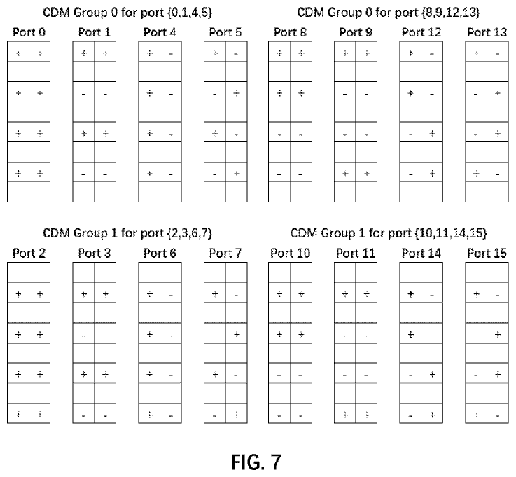

Recently, in order to meet current or future communication requirements, a scheme which supports larger number of orthogonal DMRS ports is discussed. One possible way for supporting larger number of orthogonal DMRS ports may be expanding the CDM groups so that each CDM group may provide more orthogonal OCCs. The DMRS design with CDM group expansion according to the present disclosure will be described in detail with respect to FIGS. 7-10.

In some embodiments, the legacy CDM group may be expanded to generate an expanded CDM group. The expanded CDM group may have a larger size (including larger number of OCCs) than the legacy CDM group. In order to achieve larger number of OCCs in one CDM group while maintaining the orthogonality of the OCCs in one CDM group, the number of frequency domain elements in the legacy OCCs included in the legacy CDM group may be increased. In some embodiments, the number of frequency domain elements in each of the plurality of expanded OCCs may be expanded as twice the number of frequency domain elements in each of the plurality of legacy OCCs.

By this means, the expanded CDM group including a larger size than the legacy CDM group may support more orthogonal DMRS ports. On the other hand, the frequency or time occupation of DMRS in the PRBs are not increased, and thus the CDM group expansion may be achieved without increasing the DMRS overhead.

In some embodiments, a pair of the expanded OCCs may be generated based on one legacy OCC, wherein one expanded OCC in the pair may be generated by repeating the frequency domain elements in the legacy OCC twice, and the other expanded OCC in the pair may be generated by concatenating the frequency domain elements in the legacy OCC and phase reversed frequency domain elements in the legacy OCC.

For example, a legacy OCC₀ corresponding to DMRS port 0 includes two FD-OCC elements [FD-OCC₁, FD-OCC₂]=[+, +]^{T} for DMRS symbol k. The pair of the expanded OCCs from the legacy OCC may be generated as expanded OCC₁ and expanded OCC₂. The expanded OCC₁ is expanded to include four FD-OCC elements [FD-OCC₁₁, FD-OCC₁₂, FD-OCC₁₃, FD-OCC₁₄]=[+, +, +, +]^{T}, which is generated by repeating FD-OCC elements [FD-OCC₁, FD-OCC₂] in the legacy OCC₀ twice. Further, the expanded OCC₂ is expanded to include four FD-OCC elements [FD-OCC₂₁, FD-OCC₂₂, FD-OCC₂₃, FD-OCC₂₄]=[+, +, −, −]^{T}, which is generated by concatenating the frequency domain elements in the legacy OCC₀ ([+, +]^{T}) and phase reversed frequency domain elements in the legacy OCC₀ (−[+, +]^{T}=[−, −]^{T}).

A Kronecker product operation of the FD-OCC elements [FD-OCC₁, FD-OCC₂] of one legacy OCC and an operator (+, −)^{T} may be applied to generate the doubled frequency domain elements in the pair of expanded OCCs. The element “+” in the operator denotes the repeating of FD-OCC elements, and the element “−” in the operator denotes the concatenating of the original FD-OCC elements and the phase reversed FD-OCC elements.

For example, for a legacy OCC₁ corresponding to DMRS port 1 including two FD-OCC elements [FD-OCC₁, FD-OCC₂]=[+, −]^{T} for DMRS symbol k, the four FD-OCC elements in the expanded OCC₁ may be generated as [+, −, +, −]^{T}, and the four FD-OCC elements in the expanded OCC₂ may be generated as [+, −, −, +]^{T}.

It is noted that the CDM group expansion according to the present disclosure is not limited to the above example, and different expanded OCCs may be generated. For example, A Kronecker product operation of the FD-OCC elements [FD-OCC₁, FD-OCC₂] of one legacy OCC and a different operator (−, +)^{T} may be applied to generate the doubled frequency domain elements in the pair of expanded OCCs. Further, other expanded OCCs may be generated, as long as the expanded OCCs in one expanded CDM group are orthogonal with each other.

The above expansion may be applied to each legacy OCC in the legacy CDM group. According to the expansion, one legacy OCC can be split into two new OCCs, and the total number of expanded OCCs in one expanded CDM group is doubled while the orthogonality of the expanded OCCs in one expanded CDM group is maintained. Therefore, the supportable DMRS ports can be doubled. In addition, since only FD-OCC elements are expanded while the number of TD-OCC elements are not changed, the DMRS overhead is not increased.

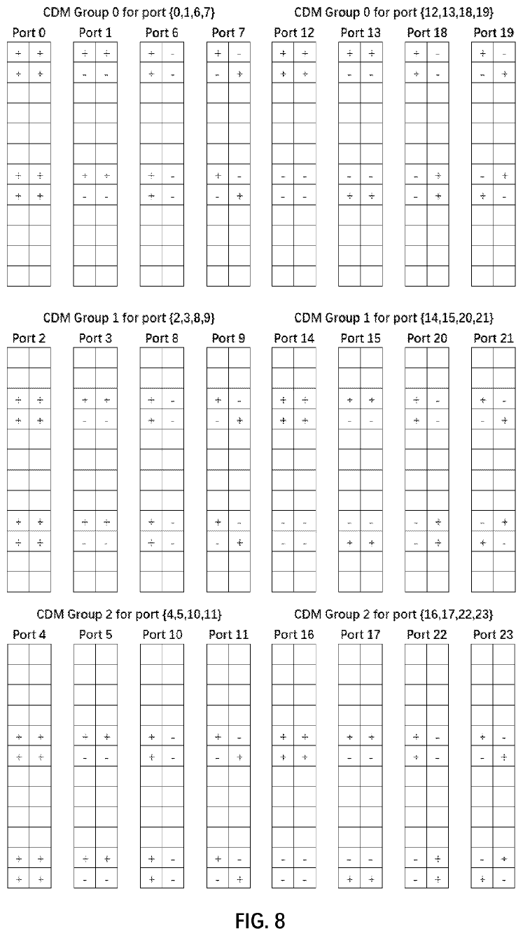

FIGS. 7 and 8 illustrate the expanded CDM groups for DMRS type 1 and DMRS type 2 respectively.

As shown in FIG. 7, the supportable DMRS ports for two-symbol DMRS in DMRS type 1 is 16, which is doubled from the maximum supportable DMRS ports (8 ports) based on the legacy CDM groups as shown in FIG. 4. Further, as shown in FIG. 8, the supportable DMRS ports for two-symbol DMRS in DMRS type 2 is 24, which is doubled from the maximum supportable DMRS ports (12 ports) based on the legacy CDM groups as shown in FIG. 6. For one-symbol DMRS, similarly, the supportable DMRS ports for DMRS type 1 may be doubled from 4 to 8, and the supportable DMRS ports for DMRS type 2 may be doubled from 6 to 12.

In some embodiments, the one expanded OCC in the pair may be assigned to the same DMRS port n corresponding to the legacy OCC, and the other expanded OCC in the pair may be assigned to a DMRS port (n+M), wherein M is the maximum number of legacy supportable DMRS ports.

For example, for DMRS type 1, M=8 for two-symbol DMRSs. Therefore, for the pair of expanded OCCs split from the legacy OCC corresponding to legacy DMRS port 0, the pair of expanded OCCs may be assigned to DMRS port 0 and DMRS port 8 respectively. For the pair of expanded OCCs split from the legacy OCC corresponding to legacy DMRS port 1, the pair of expanded OCCs may be assigned to DMRS port 1 and DMRS port 9 respectively. For other expanded OCCs, similar assignment may be performed. The assignments are shown in FIG. 7.

By the above assignment, the new DMRS ports 0 to 7 still correspond to the legacy DMRS ports 0 to 7, and thus better back-forward compatibility may be achieved, and co-scheduling of both legacy and new DMRS may be possible.

For DMRS type 2, similar assignment may be applied. For example, for DMRS type 2, M=12 for two-symbol DMRSs. Therefore, for the pair of expanded OCCs split from the legacy OCC corresponding to legacy DMRS port 0, the pair of expanded OCCs may be assigned to DMRS port 0 and DMRS port 12 respectively. For the pair of expanded OCCs split from the legacy OCC corresponding to legacy DMRS port 1, the pair of expanded OCCs may be assigned to DMRS port 1 and DMRS port 13 respectively. For other expanded OCCs, similar assignment may be performed. The assignments are shown in FIG. 8.

By the above assignment, the new DMRS ports 0 to 11 still correspond to the legacy DMRS ports 0 to 11, and thus better back-forward compatibility may be achieved, and co-scheduling of both legacy and new DMRS may be possible.

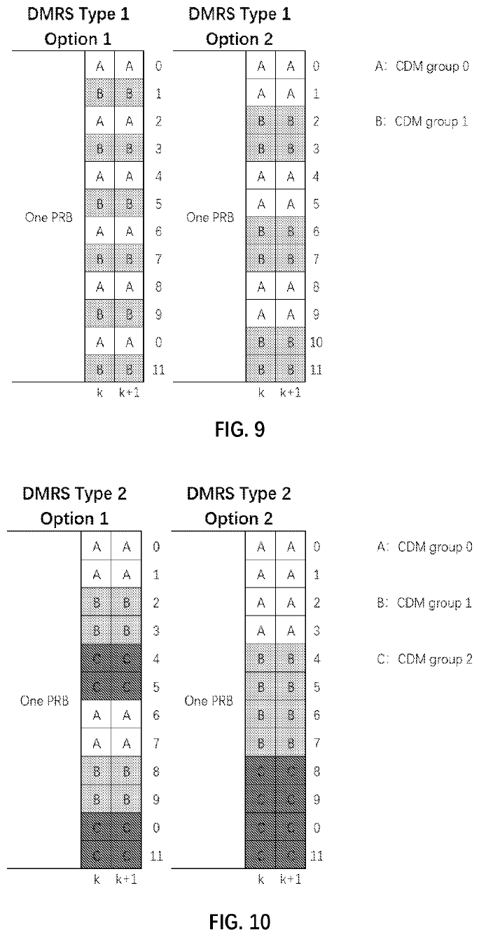

In the above description with reference to FIGS. 7 and 8, the expansion of CDM group is performed without changing the DMRS configuration types, so as to achieve better back-forward compatibility. In some embodiments, the DMRS configuration types may be redesigned together with the expansion of CDM group. In the following, FIGS. 9 and 10 may be referred to describe the two options of DMRS configuration design.

FIG. 9 illustrates DMRS pattern designs for DMRS configuration type 1 according to some embodiments disclosed herein.

Option 1 shown in FIG. 9 corresponds to the case where the DMRS configuration type is not changed as compared to the legacy DMRS configuration type. As shown in option 1 of FIG. 9, the DMRS patterns A and B are the same as the legacy DMRS type 1 shown in FIG. 3.

As another option, the DMRS design may be changed for DMRS type 1. For example, in some embodiments, as shown in option 2 of FIG. 9, frequency occupation for REs of the DMRS may be doubled by repeating frequency occupation of a legacy DMRS pattern in consecutive frequency domain resource elements.

For example, for DMRS symbol Aₖ, the frequency occupation of the DMRS RE_{k,0} in FIG. 3 is repeated in FIG. 9 as DMRS RE_{k,0} and RE_{k,1}, other DMRS REs are repeated similarly to generate new DMRS symbols A′_{k and k+1} for DMRS pattern A expressed as

$${A}_{k and k + 1}^{′} = {[ \begin{matrix}{RE}_{k , 0} , & {RE}_{k , 1} , & {RE}_{k , 4} , & {RE}_{k , 5} \\ {RE}_{k + 1 , 0} , & {RE}_{k + 1 , 1} , & {RE}_{k + 1 , 4} , & {RE}_{k + 1 , 5}\end{matrix} \begin{matrix}{RE}_{k , 8} , & {RE}_{k , 9} \\ {RE}_{k + 1 , 8} , & {RE}_{k + 1 , 9}\end{matrix} ]}^{T}$$

and B′_{k and k+1} for DMRS pattern B expressed as

$${B}_{k and k + 1}^{′} = {[ \begin{matrix}{RE}_{k , 2} , & {RE}_{k , 3} , & {RE}_{k , 6} , & {RE}_{k , 7} \\ {RE}_{k + 1 , 2} , & {RE}_{k + 1 , 3} , & {RE}_{k + 1 , 6} , & {RE}_{k + 1 , 7}\end{matrix} \begin{matrix}{RE}_{k , 10} , & {RE}_{k , 11} \\ {RE}_{k + 1 , 10} , & {RE}_{k + 1 , 11}\end{matrix} ]}^{T}$$

FIG. 10 illustrates DMRS pattern designs for DMRS configuration type 2 according to some embodiments disclosed herein.

Option 1 shown in FIG. 10 corresponds to the case where the DMRS configuration type is not changed as compared to the legacy DMRS configuration type. As shown in option 1 of FIG. 10, the DMRS patterns A, B and C are the same as the legacy DMRS type 2 shown in FIG. 5.

As another option, the DMRS design may be changed for DMRS type 2. For example, in some embodiments, as shown in option 2 of FIG. 10, frequency occupation for REs of the DMRS may be doubled by repeating frequency occupation of a legacy DMRS pattern in consecutive frequency domain resource elements.

For example, for DMRS symbol Aₖ, the frequency occupation of the DMRS RE_{k,0} and RE_{k,1} in FIG. 5 is repeated in FIG. 10 as DMRS RE_{k,0}, RE_{k,1}, RE_{k,2}, RE_{k,3}. Other DMRS REs are repeated similarly to generate new DMRS symbols A′_{k and k+1} for DMRS pattern A expressed as

$${A}_{k and k + 1}^{′} = {[ \begin{matrix}{RE}_{k , 0} , & {RE}_{k , 1} , & {RE}_{k , 2} , & {RE}_{k , 3} \\ {RE}_{k + 1 , 0} , & {RE}_{k + 1 , 1} , & {RE}_{k + 1 , 2} , & {RE}_{k + 1 , 3}\end{matrix} ]}^{T}$$

B′_{k and k+1} for DMRS pattern B expressed as

$${B}_{k and k + 1}^{′} = {[ \begin{matrix}{RE}_{k , 4} , & {RE}_{k , 5} , & {RE}_{k , 6} , & {RE}_{k , 7} \\ {RE}_{k + 1 , 4} , & {RE}_{k + 1 , 5} , & {RE}_{k + 1 , 6} , & {RE}_{k + 1 , 7}\end{matrix} ]}^{T}$$

and C′_{k and k+1} for DMRS pattern C expressed as

$${C}_{k and k + 1}^{′} = {[ \begin{matrix}{RE}_{k , 8} , & {RE}_{k , 9} , & {RE}_{k , 10} , & {RE}_{k , 11} \\ {RE}_{k + 1 , 8} , & {RE}_{k + 1 , 9} , & {RE}_{k + 1 , 10} , & {RE}_{k + 1 , 11}\end{matrix} ]}^{T}$$

According to the DMRS patterns of option 2 shown in FIGS. 9 and 10, the distance between different DMRS REs in the DMRS symbol may be kept closer than option 1, so that the change of channel conditions for different DMRS REs in the DMRS symbol may become less than the change for option 1. Therefore, option 2 may be more robust to frequency selective fading channels.

It should be noted that the expanded CDM groups described with reference to FIGS. 7 and 8 may be respectively applied to either option 1 or option 2 of the DMRS types 1 and 2.

The DMRS design with CDM group expansion according to the present disclosure may be used in the transmission between a network device and a wireless device.

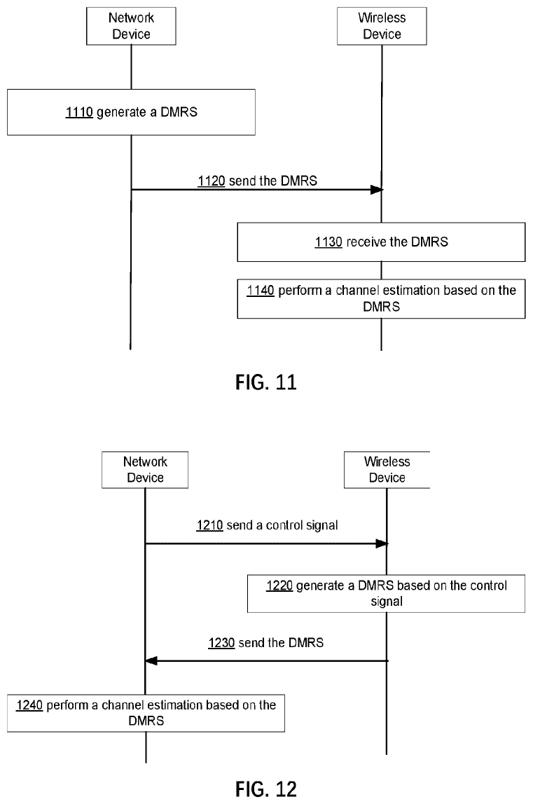

FIG. 11 illustrates a signaling diagram of an example method for downlink DMRS transmission between the network device and the wireless device. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

At 1110, the network device generates a DMRS. The DMRS may correspond the DMRS designed with CDM group expansion according to any of the embodiments described in the present disclosure.

At 1120, the network device sends the DMRS to the wireless device.

At 1130, the wireless device receives the DMRS.

At 1140, the wireless device performs a downlink channel estimation based on the DMRS.

FIG. 12 illustrates a signaling diagram of an example method for uplink DMRS transmission between the network device and the wireless device. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

At 1210, the network device sends a control signal to the wireless device. The control signal may be dynamically transmitted to the wireless device (e.g. through downlink control information (DCI)).

At 1220, the wireless device generates a DMRS based on the control signal sent at 1210. The DMRS may correspond the DMRS designed with CDM group expansion according to any of the embodiments described in the present disclosure.

At 1230, the wireless device sends the DMRS to the network device.

At 1240, the network device performs an uplink channel estimation based on the DMRS.

The DMRS discussed in FIG. 11 or FIG. 12 may be based on the DMRS design with CDM group expansion according to one or more of the above-described embodiments of the present disclosure. Further, the DMRS design with CDM group expansion according to the present disclosure may be applied as a common design for both uplink and downlink DMRS. This would especially work for CP-OFDM (Circular Prefix-OFDM) in which the same DMRS patterns are used in both downlink and uplink.

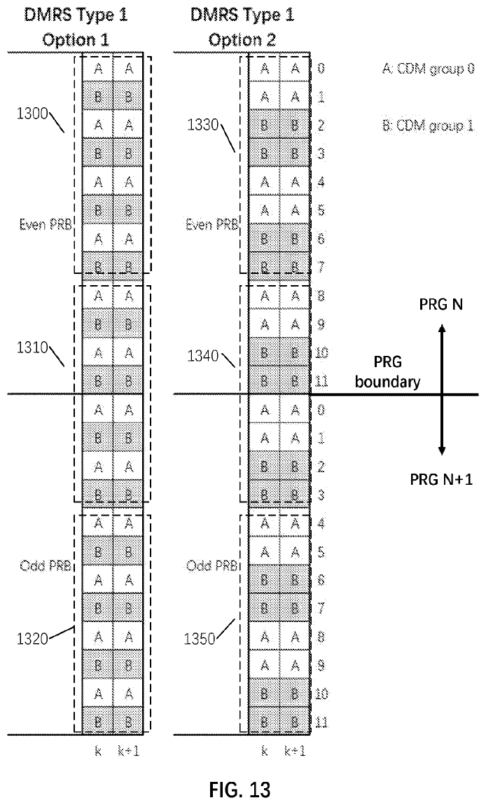

FIG. 13 illustrates a case where an expanded CDM crosses a precoding resource block group (PRG) boundary according to some embodiments disclosed herein.

For DMRS type 1, since the size of an expanded CDM group (equivalent to the size of an expanded OCC included in the expanded CDM group) in frequency domain is 4 FD-OCC elements, while the total number of DMRS REs in frequency domain is 6, there will be a case where the CDM group crosses two different PRBs. Further, a PRG may include two or more PRBs in which the same precoding is performed to the included two or more PRBs. Therefore, there is a case that the expanded CDM group crosses the PRG boundary. It is noted that the expression “a CDM group crosses the PRG boundary” means that the DMRS REs which are to be coded by one OCC in the CDM group crosses the PRG boundary.

As shown in FIG. 13, an even PRB and an odd PRB are consecutive and belong to PRG N and PRG N+1 respectively.

For DMRS pattern A in option 1 of DMRS type 1, one expanded OCC (for example, the repeated

$$OCC = {[ \begin{matrix}+ , & - , & + , & - \\ + , & - , & + , & -\end{matrix} ]}^{T} )$$

included in an expanded CDM group is used for coding the two-symbol DMRS. For

$${[ \begin{matrix}{RE}_{k , 0} , & {RE}_{k , 2} , & {RE}_{k , 4} , & {RE}_{k , 6} \\ {RE}_{k + 1 , 0} , & {RE}_{k + 1 , 2} , & {RE}_{k + 1 , 4} , & {RE}_{k + 1 , 6}\end{matrix} ]}^{T}$$

occupied as DMRS REs in the even PRB (which is denoted in FIG. 13 as RE set 1300 surrounded by a dotted box), they are coded by the expanded OCC. For

$${[ \begin{matrix}{RE}_{k , 4} , & {RE}_{k , 6} , & {RE}_{k , 8} , & {RE}_{k , 10} \\ {RE}_{k + 1 , 4} , & {RE}_{k + 1 , 6} , & {RE}_{k + 1 , 8} , & {RE}_{k + 1 , 10}\end{matrix} ]}^{T}$$

occupied as DMRS REs in the odd PRB (which is denoted in FIG. 13 as RE set 1320 surrounded by a dotted box), they are coded by the same one expanded OCC. Further, for the rest DMRS RE set 1310 including DMRS REs in both of the even and odd PRBs, they are coded by the same one expanded OCC. Therefore, the expanded OCC for coding the DMRS may be regarded as crossing the PRG boundary, which means that the expanded CDM group crosses the PRG boundary.

Similarly, for option 2 in DMRS type 1, there are three DMRS RE sets 1330, 1340 and 1350 to be coded by the same expanded OCC, wherein the DMRS RE set 1340 crosses the PRG boundary. Therefore, the expanded OCC for coding the DMRS is regarded as crossing the PRG boundary, which means the expanded CDM group crosses the PRG boundary.

One PRG may include two or more PRBs, and the same precoding is applied to the two or more PRBs. For another PRG, a different precoding may be configured. In this situation, the DMRS RE set crossing the PRG boundary may be precoded differently while the same expanded OCC is used for coding the DMRS set, so that the accuracy of channel estimation based on this DMRS RE set may be affected. Therefore, in some embodiments, the network device may configure the same precoding for two consecutive PRGs (such as PRG N and PRG N+1 shown in FIG. 13) for which the expanded CDM group crosses a boundary between the two consecutive PRGs.

By this configuration, for the DMRS RE set crossing the PRG boundary, the same precoding is applied, and thus accuracy of channel estimation based on this DMRS RE set may be ensured.

In some embodiments, when the wireless device receives the DMRS sent from the network device, the wireless device may not use the DMRS for channel estimation if the expanded CDM group crosses a boundary between two consecutive PRGs. For example, the DMRS RE set 1310 or 1340 may not be used by the wireless device for channel estimation because the corresponding CDM group crosses the PRG boundary. Therefore, even if the DMRS RE set crossing the PRG boundary are coded by one expanded OCC but are differently precoded, this DMRS RE set may not be used by the wireless device for channel estimation, and the accuracy of channel estimation may not be affected by that DMRS RE set.

Next, the alignment of the CDM group will be discussed.

For frequency selective precoding, the PRG is configured with reference to a fixed reference point (e.g., Point A, which corresponds to common resource block 0).

In some embodiments, the network device may configure a starting point of the expanded CDM group as referring to a reference point for configuring a PRG (such as Point A). “A starting point of an expanded CDM group” according to the present disclosure means a starting point (e.g., PRB) to code the DMRS REs with one expanded OCC in the expanded CDM group. By this configuration, the coding for DMRS with the expanded CDM group may be aligned with the PRG, so as to avoid the CDM group crossing the PRG boundary (and the expanded OCC for coding the DMRS crossing the PRG boundary).

For resource allocation type 0 configured with a bitmap, a resource block group (RBG) is configured with reference to Point A. The RBG is configured to include even number of PRBs. For even number of PRBs, the CDM group will not cross the PRG boundary, because the expanded OCC will always repeat three times in two consecutive PRBs. Therefore, by configuring the starting point of the expanded CDM group as referring to the same Point A, the case where the CDM group crossing the PRG boundary may be avoided.

For resource allocation type 1 configured with a starting PRB of scheduled physical downlink shared channel (PDSCH) and the number of PRBs for the PDSCH, in some embodiments, the network device may configure the starting PRB of PDSCH as having the even number of PRB distance to the reference point, in addition to configuring the starting point of the expanded CDM group for coding the DMRS as referring to the same Point A. By this means, since the starting PRB of PDSCH is configured as having the even number of PRB distance to Point A, the case where the CDM group crossing the PRG boundary may be avoided.

In some embodiments, if the number of a plurality frequency domain resource elements to be occupied by the DMRS in one PRB next to a boundary of the PRG is less than the size of the expanded OCC in frequency domain, the network device may transmit the DMRS in which frequency occupation of the plurality of frequency domain resource elements is excluded, which means the transmission of the plurality of frequency domain resource elements of the DMRS is canceled. For example, if there are only 2 DMRS REs in frequency domain in one PRB next to the PRG boundary, while the expanded OCC to be used for coding the 2 DMRS REs has a size of 4 FD-OCC elements, there will be not enough number of DMRS REs for the coding. In this case, the corresponding 2 DMRS REs will not be transmitted.

The above embodiments have disclosed the DMRS pattern design with CDM group expansion. In the following, the DMRS indication design with CDM group expansion will be discussed.

A legacy DMRS indication is used for indicating legacy DMRS ports to be used by the DMRS. The legacy DMRS indication may be dynamically configured (e.g. through DCI) by the network device. The wireless device may determine the corresponding legacy DMRS ports based on the legacy DMRS indication by referring to a legacy antenna port indication table.

In some embodiments, the legacy antenna port indication table may be reused for the DMRS indication according to the present disclosure.

For each legacy DMRS port indicated by DCI, it corresponds to two new ports. For example, as described above, a legacy DMRS port n may be split into a pair of new DMRS port n and new DMRS port (n+M), wherein M is the maximum number of legacy supportable DMRS ports. For DMRS type 1, M=4 for one-symbol DMRS, and M=8 for two-symbol DMRS. For DMRS type 2, M=6 for one-symbol DMRS, and M=12 for two-symbol DMRS.

In some embodiments, the network device may indicate the wireless device a correspondence of the DMRS and the DMRS ports. The correspondence indicates one of (1) the DMRS corresponding to DMRS port n; (2) the DMRS corresponding to DMRS port (n+M); (3) the DMRS corresponding to both DMRS port n and DMRS port (n+M); and (4) the DMRS corresponding to neither DMRS port n nor DMRS port (n+M).

By this means, by further using 2 bits of correspondence indication for example, the legacy antenna port indication table may be reused and the DMRS indication according to the present disclosure may have a back-forward compatibility.

In some embodiments, one correspondence may be indicated for a plurality of the DMRSs. For example, the correspondence may be semi-statically configured (e.g., through radio resource control (RRC) signaling) for a plurality of the DMRSs, so that for these DMRSs, the same correspondence of DMRS and DMRS ports are applied. By this means, the overhead for correspondence indication may be lowered. The correspondence can also be configured via Medium Access Control (MAC) Control Element (CE) or DCI.

In some embodiments, the correspondence may be indicated separately for each DMRS. For example, the correspondence may be dynamically configured (e.g. through DCI) by the network device. By this means, a flexible correspondence of DMRS and DMRS ports may be achieved.

The above DMRS indication according to the present disclosure is described by an example of downlink DMRS. It should be noted that the DMRS indication design according to the present disclosure may be similarly applied to uplink DMRS. To be more specific, by the DMRS indication according to the present disclosure, legacy antenna port indication tables in 3GPP specification (e.g, 38.212) for both downlink and uplink may be reused based on the DMRS indication design according to the present disclosure. The legacy antenna port indication tables include Table 7.3.1.1.2-8/9/10/11/12/13/14/15/16/17/18/19/20/21/22/23 for UL DCI Format 0_1/0_2, and Table 7.3.1.2.2-1/2/3/4/1A/2A/3A/4A or DL DCI Format 1_1/1_2, which are shown below.

The legacy DMRS indication corresponds to the column “value” of the following tables, and the corresponding DMRS port(s) may be determined based on the column “DMRS port(s)” in these tables. Taking table 7.3.1.2.2-3 for example, if the DMRS indication value is “10”, it may be determined that the DMRS ports 0-3 are to be used by the transmission of DMRS.

By adding a correspondence indication of the DMRS and the DMRS ports, if the correspondence indicates (1) the DMRS corresponding to DMRS port n, then the DMRS ports 0-3 may be determined for the DMRS indication value of “10”. If the correspondence indicates (2) the DMRS corresponding to DMRS port (n+M), then the DMRS ports M-(3+M) may be determined. If the correspondence indicates (3) the DMRS corresponding to both DMRS port n and DMRS port (n+M), then the DMRS ports 0-3 and M-(3+M) may be determined. Further, if the correspondence indicates (4) the DMRS corresponding to neither DMRS port n nor DMRS port (n+M), no DMRS port is determined.

TABLE 7.3.1.1.2-8
Antenna port(s), transform precoder is disabled, dmrs-
Type = 1, maxLength = 1, rank = 1

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 7.3.1.1.2-9
Antenna port(s), transform precoder is disabled, dmrs-
Type = 1, maxLength = 1, rank = 2

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 2 | 0, 2 |
| 4-7 | Reserved | Reserved |

TABLE 7.3.1.1.2-10
Antenna port(s), transform precoder is disabled, dmrs-
Type = 1, maxLength = 1, rank = 3

| Value | Number of DMRS CDM group(s) without data | DMRS port(s) |
|---|---|---|
| 0 | 2 | 0-2 |
| 1-7 | Reserved | Reserved |

TABLE 7.3.1.1.2-11
Antenna port(s), transform precoder is disabled, dmrs-
Type = 1, maxLength = 1, rank = 4

| Value | Number of DMRS CDM group(s) without data | DMRS port(s) |
|---|---|---|
| 0 | 2 | 0-3 |
| 1-7 | Reserved | Reserved |

TABLE 7.3.1.1.2-12
Antenna port(s), transform precoder is disabled, dmrs-
Type = 1, maxLength = 2, rank = 1

| | Number of DMRS CDM | | Number of front- |
|---|---|---|---|
| Value | group(s) without data | DMRS port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 7.3.1.1.2-13
Antenna port(s), transform precoder is disabled, dmrs-
Type = 1, maxLength = 2, rank = 2

| | Number of DMRS CDM | | Number of front- |
|---|---|---|---|
| Value | group(s) without data | DMRS port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

TABLE 7.3.1.1.2-14
Antenna port(s), transform precoder is disabled, dmrs-
Type = 1, maxLength = 2, rank = 3

| | Number of DMRS CDM | | Number of front- |
|---|---|---|---|
| Value | group(s) without data | DMRS port(s) | load symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

TABLE 7.3.1.1.2-15
Antenna port(s), transform precoder is disabled, dmrs-
Type = 1, maxLength = 2, rank = 4

| | Number of DMRS CDM | | Number of front- |
|---|---|---|---|
| Value | group(s) without data | DMRS port(s) | load symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

TABLE 7.3.1.1.2-16
Antenna port(s), transform precoder is disabled, dmrs-
Type = 2, maxLength = 1, rank = 1

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

TABLE 7.3.1.1.2-17
Antenna port(s), transform precoder is disabled, dmrs-
Type = 2, maxLength = 1, rank = 2

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

TABLE 7.3.1.1.2-18
Antenna port(s), transform precoder is disabled, dmrs-
Type = 2, maxLength = 1, rank = 3

| Value | Number of DMRS CDM group(s) without data | DMRS port(s) |
|---|---|---|
| 0 | 2 | 0-2 |
| 1 | 3 | 0-2 |
| 2 | 3 | 3-5 |
| 3-15 | Reserved | Reserved |

TABLE 7.3.1.1.2-19
Antenna port(s), transform precoder is disabled, dmrs-
Type = 2, maxLength = 1, rank = 4

| Value | Number of DMRS CDM group(s) without data | DMRS port(s) |
|---|---|---|
| 0 | 2 | 0-3 |
| 1 | 3 | 0-3 |
| 2-15 | Reserved | Reserved |

TABLE 7.3.1.1.2-20
Antenna port(s), transform precoder is disabled, dmrs-
Type = 2, maxLength = 2, rank = 1

| | Number of DMRS CDM | | Number of front- |
|---|---|---|---|
| Value | group(s) without data | DMRS port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

TABLE 7.3.1.1.2-21
Antenna port(s), transform precoder is disabled, dmrs-
Type = 2, maxLength = 2, rank = 2

| | Number of DMRS CDM | | Number of front- |
|---|---|---|---|
| Value | group(s) without data | DMRS port(s) | load symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

TABLE 7.3.1.1.2-22
Antenna port(s), transform precoder is disabled, dmrs-
Type = 2, maxLength = 2, rank = 3

| | Number of DMRS CDM | | Number of front- |
|---|---|---|---|
| Value | group(s) without data | DMRS port(s) | load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

TABLE 7.3.1.1.2-23
Antenna port(s), transform precoder is disabled, dmrs-
Type = 2, maxLength = 2, rank = 4

| | Number of DMRS CDM | | Number of front- |
|---|---|---|---|
| Value | group(s) without data | DMRS port(s) | load symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

TABLE 7.3.1.2.2-1
Antenna port(s) (1000 + DMRS port), dmrs-Type = 1, maxLength = 1
One Codeword: Codeword 0 enabled, Codeword 1 disabled

| | Number of DMRS | |
|---|---|---|
| | CDM group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 7.3.1.2.2-1A
Antenna port(s) (1000 + DMRS port), dmrs-Type = 1, maxLength = 1
One Codeword Codeword 0 enabled, Codeword 1 disabled

| | Number of DMRS | |
|---|---|---|
| | CDM group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12 | 2 | 0, 2, 3 |
| 13-15 | Reserved | Reserved |

TABLE 7.3.1.2.2-2
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 7.3.1.2.2-2A
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

TABLE 7.3.1.2.2-3
Antenna port(s) (1000 + DMRS port), dmrs-
Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS CDM | | | DMRS CDM | |
| | group(s) | DMRS | | group(s) | DMRS |
| Value | without data | port(s) | Value | without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

TABLE 7.3.1.2.2-3A
Antenna port(s) (1000 + DMRS port), dmrs-
Type = 2, maxLength = 1

| One codeword: | | | Two codewords: | | |
|---|---|---|---|---|---|
| Codeword 0 enabled. | | | Codeword 0 enabled, | | |
| Codeword 1 disabled | | | codeword 1 enabled | | |
| | Number of | | | Number of | |
| | DMRS CDM | | | DMRS CDM | |
| | group(s) | DMRS | | group(s) | DMRS |
| Value | without data | port(s) | Value | without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25-31 | Reserved | Reserved | | | |

TABLE 7.3.1.2.2-4
Antenna port(s) (1000 + DMRS port), dmrs-Type = 2, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58-63 | Reserved | Reserved | Reserved | | | | |

TABLE 7.3.1.2.2-4A
Antenna port(s) (1000 + DMRS port), dmrs-Type = 2, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 59-63 | Reserved | Reserved | Reserved | | | | |

Embodiments contemplated herein include an apparatus comprising means to perform one or more elements of the signaling illustrated in FIGS. 11 and 12. This apparatus may be, for example, an apparatus of a base station (such as a network device 218 that is a base station, as described herein) or an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the signaling illustrated in FIGS. 11 and 12. This non-transitory computer-readable media may be, for example, a memory of a base station (such as a memory 222 of a network device 218 that is a base station, as described herein) or a memory of a UE (such as a memory 206 of a wireless device 202 that is a UE, as described herein).

Embodiments contemplated herein include an apparatus comprising logic, modules, or circuitry to perform one or more elements of the signaling illustrated in FIGS. 11 and 12. This apparatus may be, for example, an apparatus of a base station (such as a network device 218 that is a base station, as described herein) or an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the signaling illustrated in FIGS. 11 and 12. This apparatus may be, for example, an apparatus of a base station (such as a network device 218 that is a base station, as described herein) or an apparatus of a UE (such as a wireless device 202 that is a UE, as described herein).

Embodiments contemplated herein include a signal as described in or related to one or more elements of the signaling illustrated in FIGS. 11 and 12.

Embodiments contemplated herein include a computer program or computer program product comprising instructions, wherein execution of the program by a processing element is to cause the processing element to carry out one or more elements of the signaling illustrated in FIGS. 11 and 12. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein). The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A network device, comprising:
a memory, in which instructions are stored; and
at least one processor, configured to execute the instructions stored in the memory to generate a demodulation reference signal (DMRS); and
send the DMRS to a wireless device,
wherein the DMRS is coded with one of a plurality of expanded orthogonal cover codes (OCCs) belonging to an expanded code division multiplexing (CDM) group, the expanded CDM group is generated by expanding a legacy CDM group including a plurality of legacy OCCs, and the number of frequency domain elements in each of the plurality of expanded OCCs is expanded as twice the number of frequency domain elements in each of the plurality of legacy OCCs.

2. The network device of claim 1, wherein
frequency occupation for resource elements of the DMRS is doubled by repeating frequency occupation of a legacy DMRS pattern in consecutive frequency domain resource elements.

3. The network device of claim 1, wherein
a pair of the expanded OCCs are generated based on one legacy OCC, wherein one expanded OCC in the pair is generated by repeating the frequency domain elements in the legacy OCC twice, and the other expanded OCC in the pair is generated by concatenating the frequency domain elements in the legacy OCC and phase reversed frequency domain elements in the legacy OCC.

4. The network device of claim 1, wherein
the at least one processor is further configured to execute the instructions stored in the memory to
configure the same precoding for two consecutive precoding resource block groups (PRGs) for which the expanded CDM group crosses a boundary between the two consecutive PRGs.

5. The network device of claim 1, wherein
the at least one processor is further configured to execute the instructions stored in the memory to
configure a starting point of the expanded CDM group as referring to a reference point for configuring a PRG.

6. The network device of claim 5, wherein
the at least one processor is further configured to execute the instructions stored in the memory to
configure a starting physical resource block (PRB) of scheduled physical downlink shared channel (PDSCH) as having the even number of PRB distance to the reference point.

7. The network device of claim 5, wherein
the at least one processor is further configured to execute the instructions stored in the memory to
if the number of a plurality frequency domain resource elements to be occupied by the DMRS in one PRB next to a boundary of the PRG is less than the size of the expanded OCC in frequency domain, cancel transmission of the plurality of frequency domain resource elements of the DMRS.

8. The network device of claim 3, wherein
the one expanded OCC in the pair is assigned to the same DMRS port n corresponding to the legacy OCC, and the other expanded OCC in the pair is assigned to a DMRS port (n+M), wherein M is the maximum number of legacy supportable DMRS ports.

9. The network device of claim 8, wherein
the at least one processor is further configured to execute the instructions stored in the memory to
indicate the wireless device a correspondence of the DMRS and the DMRS ports,
wherein the correspondence indicates one of
(1) the DMRS corresponding to DMRS port n;
(2) the DMRS corresponding to DMRS port (n+M);
(3) the DMRS corresponding to both DMRS port n and DMRS port (n+M);
(4) the DMRS corresponding to neither DMRS port n nor DMRS port (n+M).

10. The network device of claim 9, wherein
one correspondence is indicated for a plurality of the DMRSs.

11. A wireless device, comprising:
a memory, in which instructions are stored; and
at least one processor, configured to execute the instructions stored in the memory to receive a demodulation reference signal (DMRS) from a network device; and
perform a channel estimation based on the DMRS,
wherein the first DMRS is coded with one of a plurality of first orthogonal cover codes (OCCs) belonging to a first code division multiplexing (CDM) group, the first CDM group is generated by expanding a second CDM group including a plurality of second OCCs and the number of frequency domain elements in each of the plurality of first OCCs is expanded as twice the number of frequency domain elements in each of the plurality of second OCCs.

12. The wireless device of claim 11, wherein
frequency occupation for resource elements of the DMRS is doubled by repeating frequency occupation of a legacy DMRS pattern in consecutive frequency domain resource elements.

13. The wireless device of claim 11, wherein
a pair of the expanded OCCs are generated based on one legacy OCC, wherein one expanded OCC in the pair is generated by repeating the frequency domain elements in the legacy OCC twice, and the other expanded OCC in the pair is generated by concatenating the frequency domain elements in the legacy OCC and phase reversed frequency domain elements in the legacy OCC.

14. The wireless device of claim 11, wherein
the at least one processor is further configured to execute the instructions stored in the memory to
not use the DMRS for channel estimation if the expanded CDM group crosses a boundary between two consecutive PRGs.

15. The wireless device of claim 13, wherein
the one expanded OCC in the pair is assigned to the same DMRS port n corresponding to the legacy OCC, and the other expanded OCC in the pair is assigned to a DMRS port (n+M), wherein M is the maximum number of legacy supportable DMRS ports.

16. The wireless device of claim 15, wherein
the at least one processor is further configured to execute the instructions stored in the memory to
receive, from the wireless device, an indication of correspondence of the DMRS and the DMRS ports,
wherein the correspondence indicates one of
(1) the DMRS corresponding to DMRS port n;
(2) the DMRS corresponding to DMRS port (n+M);
(3) the DMRS corresponding to both DMRS port n and DMRS port (n+M);
(4) the DMRS corresponding to neither DMRS port n nor DMRS port (n+M).

17. The wireless device of claim 16, wherein
one correspondence is indicated for a plurality of the DMRSs.

18-20. (canceled)

21. A method for a wireless device, comprising:
receiving a demodulation reference signal (DMRS) from a network device; and
performing a channel estimation based on the DMRS,
wherein the first DMRS is coded with one of a plurality of first orthogonal cover codes (OCCs) belonging to a first code division multiplexing (CDM) group, the first CDM group is generated by expanding a second CDM group including a plurality of second OCCs and the number of frequency domain elements in each of the plurality of first OCCs is expanded as twice the number of frequency domain elements in each of the plurality of second OCCs.

22-25. (canceled)
